(19) United States
(12) Patent Application Publication
(10) Pub. No.: US 2007/0299165 A1
(43) Pub. Date: Dec. 27, 2007

(54) Phenyl-containing silicone epoxy formulations useful as encapsulants for LED applications

(75) Inventors: Deborah Ann Haitko, Schenectady, NY (US); Slawomir Rubinsztajn, Ballston Spa, NY (US)

Correspondence Address: FAY SHARPE LLP, 1100 SUPERIOR AVENUE, SEVENTH FLOOR, CLEVELAND, OH, 44114, US

(73) Assignee: GELcore LLC

(21) Appl. No.: 11/475,804

(22) Filed: Jun. 27, 2006

(51) Int. Cl. C08L 63/00; C08L 83/06

(52) U.S. Cl. 523/459; 525/523; 525/533; 525/477

(57) ABSTRACT

An encapsulant composition is provided. The composition includes an epoxy composition including at least a silicone and a phenyl group, a curing agent, and a filler.

### BACKGROUND OF THE INVENTION

This invention relates to light emitting devices. Light emitting diodes (LEDs) are well-known solid-state devices that can generate light having a peak wavelength in a specific region of the visible spectrum. Early LEDs emitted light having a peak wavelength in the red region of the light spectrum, and were often based on aluminum, indium, gallium and phosphorus semiconducting materials. More recently, LEDs based on Group III-nitride where the Group III element can be any combination of Ga, In, Al, B, and Ti have been developed that can emit light having a peak wavelength in the green, blue and ultraviolet regions of the spectrum. The present invention relates to an epoxy-based encapsulant formulation for such lighting devices.

An epoxy for this type of application should be homogenous, flexible, and optically transparent. The epoxy must also be able to withstand thermal shock testing typifying thermal conditions in normal LED applications. Current epoxies useful in encapsulant formulations may withstand thermal shock testing, but fall short in terms of optical transparency over extended use. Moreover, these formulations may degrade after extended use, or can develop cracks or peeling from the substrate of the lighting device.

It would therefore be desirable to develop an encapsulant material that is able to withstand thermal shock testing while maintaining optical transparency over a period of extended use. Additionally, improved flexibility in an encapsulant would lead to reduced stress in the device due to a mismatch in the coefficient of thermal expansion between the inorganic chip and packaging and an organic encapsulant.

### SUMMARY OF THE INVENTION

According to one aspect of the invention, an encapsulant composition is provided. The composition includes an epoxy composition including at least a silicone and a phenyl group and a curing agent.

In another embodiment, a method for forming an encapsulant composition is provided. The method includes the step of combining an epoxy composition including at least a silicone and a phenyl group, and a curing agent.

In a third embodiment, an electronic chip package is provided. The package includes an encapsulant composition comprised of an epoxy composition including at least a silicone and a phenyl group and a curing agent; and an electronic chip; and a phosphor.

### BRIEF DESCRIPTION OF THE DRAWINGS

FIG. 1 is a schematic sectional view of a lamp employing the encapsulant material of the present invention.

### DETAILED DESCRIPTION OF THE INVENTION

An epoxy based composition has been developed for various applications. The resin is suitable for use as an encapsulant material in lighting devices. One particular use is for encapsulating high density interconnected multichip modules. The epoxy resin composition of the present invention preferably comprises an epoxy resin and a curing agent.

Preferred resins include epoxies with at least one silicone and at least one phenyl group. Silicone-epoxy resins of the present invention typically have the formula:

MₐM′_{b}D_{c}D′_{d}TₑT′_{f}Q_{g}

where the subscripts a, b, c, d, e, f and g are zero or a positive integer, subject to the limitation that the sum of the subscripts b, d and f is one or greater; where M has the formula:

R¹₃SiO_{1/2},

M′ has the formula:

(Z)R²₂SiO_{1/2},

D has the formula:

R³₂SiO_{2/2},

D′ has the formula:

(Z)R⁴SiO_{2/2},

T has the formula:

R⁵SiO_{3/2},

T′ has the formula:

(Z)SiO_{3/2},

and Q has the formula SiO_{4/2}, where each R¹, R², R³, R⁴, R⁵ is independently at each occurrence a hydrogen atom, C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents an epoxy group. The term “alkyl” as used in various embodiments of the present invention is intended to designate both normal alkyl, branched alkyl, aralkyl, and cycloalkyl radicals. Normal and branched alkyl radicals are preferably those containing in a range between about 1 and about 12 carbon atoms, and include as illustrative non-limiting examples methyl, ethyl, propyl, isopropyl, butyl, tertiary-butyl, pentyl, neopentyl, and hexyl. Cycloalkyl radicals represented are preferably those containing in a range between about 4 and about 12 ring carbon atoms. Some illustrative non-limiting examples of these cycloalkyl radicals include cyclobutyl, cyclopentyl, cyclohexyl, methylcyclohexyl, and cycloheptyl. Preferred aralkyl radicals are those containing in a range between about 7 and about 14 carbon atoms; these include, but are not limited to, benzyl, phenylbutyl, phenylpropyl, and phenylethyl. Aryl radicals used in the various embodiments of the present invention are preferably those containing in a range between about 6 and about 14 ring carbon atoms. Some illustrative non-limiting examples of these aryl radicals include phenyl, biphenyl, and naphthyl. An illustrative non-limiting example of a suitable halogenated moiety is trifluoropropyl.

### Combinations of epoxy monomers and oligomers may be used in the present invention.

Exemplary resins include tris(Beta-(3,4-epoxycyclohexyl)ethyldimethylsiloxy)phenylsilane (1), 1,5-bis(Beta-(3,4-epoxycyclohexyl)ethyldimethylsiloxy)-3,3-diphenyltrisiloxane (2), 1,7-bis(Beta-(3,4-epoxycyclohexyl)ethyldimethylsiloxy)-3,3,5,5-tetraphenyltetrasiloxane (3).

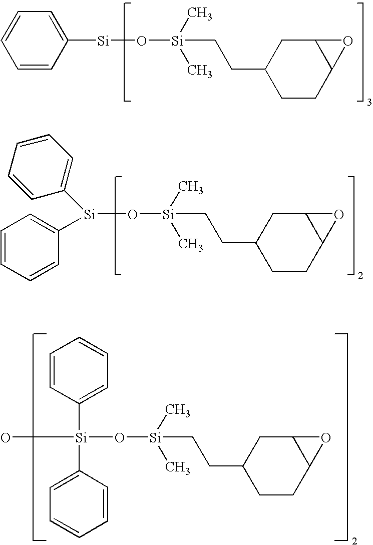

The resins of the present invention may be substituted. Cycloaliphatic groups are beneficial due to their resistance to thermal and photo aging.

Resins in accord with the present invention demonstrate viscosity and optical properties sufficient to withstand UV/Thermal conditions typical of LED operating conditions.

A curing agent is preferably added to the present composition. The curing agent is preferably a multifunctional organic compound capable of reacting with the epoxy functionalities located within the composition. Suitable curing agents include resins obtained by the condensation or co-condensation of phenols (e.g. phenol, cresol, resorcin, catechol, bisphenol A and bisphenol F) and/or naphthols (e.g., α-naphthol, β-naphthol, and dihydroxynaphthalene) with aldehydes such as formaldehyde in the presence of an acid catalyst; aralkyl type phenolic resins (e.g., phenol-aralkyl resins and naphthol-aralkyl resins); and mixtures thereof. Other preferred curing agents include amines, amides, phenols, thiols, carboxylic acids, carboxylic anhydrides, and mixtures thereof. The most preferred curing agents are anhydrides, and examples of exemplary curing agents include cis-1,2-cyclo hexane dicarboxylic anhydride, methylhexohydropthalic anhydride, and mixtures thereof.

The curing agent is preferably mixed in such an amount that the molar ratio of anhydride groups to epoxy groups is from about 0.5 to about 1.5 and more preferably from about 0.8 to about 1.2. If the molar content of anhydride is too low, the epoxy resin may cure insufficiently to tend to make the cured product have poor heat resistance, moisture resistance, and electrical properties. If it is more than about 1.5, the curing agent constituent is present in excess, so that the anhydride groups may remain in a large quantity in the cured-product resin. This could result in poor electrical properties and moisture resistance.

A curing accelerator may also be preferably mixed with the resin of the present invention to accelerate the etherification reaction of epoxy groups with phenolic hydroxyl groups. Preferred curing accelerators include tertiary amines, such as 1,8-diazabicyclo[5.4.0]undecene-7,1,5-diazabicyclo[5.4.0]nonene, 5,6-dibutylamino-1,8-diazabicyclo[5.4.0]undecene-7, benzyldimethylamine, triethanolamine, dimethylaminoethanol and tris(dimethylaminomethyl)phenol; imidazoles, such as 2-methylimidazole, 2-phenylimidazole, and 2-phenyl-4-methylimidazole; organophosphines, such as tributylphosphine, methyldiphenylphosphine, triphenylphosphine, diphenylphosphine, and phenylphosphine; phosphorus compounds having intramolecular polarization, including any of the above organophosphines to which a compound having a π-bond such as maleic anhydride, benzoquinone, or diazophenylmethane has been added; tetraphenyl phophonium tetraphenylborate, triphenylphosphine tetraphenylborate, 2-ethyl-4-methylimidazole tetraphenylborate, N-methyltetraphenylphosphonium tetraphenylborate, triphenylphosphonium triphenylborate, and mixtures thereof.

The curing accelerator may preferably be mixed in an amount of from about 0.01 to 5 parts by weight, and more preferably from about 0.1 to about 3 parts by weight, based on 100 parts by weight of the epoxy resin.

Adhesion promoters may also be added to the present invention. Adhesion promoters commonly used in the art may be selected. Preferred adhesion promoters include silane type coupling agents such as vinyltrichlorosilane, vinyltriethoxysilane, vinyltris(β-methoxyethyoxy) silane, γ-methacryloxypropyltrimethoxysilane, β-(3,4-epoxydicyclohexyl)ethyltrimethoxysilane, γ-glycidoxypropyltrimethoxysilane, vinlytriacetoxysilane, γ-mercaptopropyltrimethoxysilane, γ-aminopropyltriethoxysilane, γ-[bis-(β-hydroxyethyl)]aminopropyltriethoxysilane, N-β-(aminoethyl)-γ-aminopropyltrimethoxysilane, γ-(β-aminoethyl)aminopropyldimethoxymethylsilane, N-(trimethoxysiliylpropyl)ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltrimethoxysilaen, vinyltrimethoxysilane and γ-mercaptopropylmethyldimethoxysilane; titanate type coupling agents such as isopropyltriisosteroyl titanate, isopropyltris(diocyl pyrophosphate) titanate, isoprpyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isopropyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisopropylbis(dioctyl phosphite) titanate; and mixtures thereof.

Other bonding enhancers can be added to the present adhesive composition to improve the interaction of the components within the composition. Preferred bonding enhancers are multifunctional epoxies. More preferably, the bonding enhancers are epoxies with at least about 3 epoxy moieties within the compound. Exemplary bonding enhancers include N,N′-diglycidyl-p-aminophenyl-glycidyl ether, triglycidyl p-aminophenol derived resins, 1,3,5-triglycidyl isocyanurate, tetraglycidylmethylenedianiline, and glycidyl ether of novolac epoxies. The bonding enhancers are preferably added to the present composition in an amount between about 3 and 30% by weight of the total composition, more preferably between about 9 and 26 wt %.

Additional additives known in the art may also be added to the present epoxy composition. For example, a release agent such as a higher fatty acid (e.g., carnauba wax or a polyethylene type wax), a modifier such as silicone oil or silicone rubber, an ion trapper such as hydrotalcite or antimony-bismuth and mixtures thereof may optionally be mixed as other additives.

The encapsulant epoxy resin composition of the present invention may be prepared by methods known in the art as long as the constituent materials can uniformly be dispersed and mixed. As a commonly available method, a method may be used in which stated amounts of the constituent materials are thoroughly mixed by means of a mixer and thereafter melt-kneaded by means of a heat roller or extruder, followed by cooling and pulverization. It may be preferred to mold the product thus obtained into tablets in such a size and weight that may suit to molding conditions, so as to be usable with ease.

A tackifier may be added to the present composition. The tackifier can be added to improve thermal resistance. Preferred tackifiers are thermoset resins such as phenolics and melamines. Especially preferred tackifiers are carboxyl terminated compounds. Exemplary tackifying agents include melamine formaldehydes, urea formaldehydes, phenol formaldehydes, epoxidized ortho cresol novolacs, and mixtures thereof. Tackifiers can be added to the present composition in an amount between about 5 and 20 wt % of the total composition, more preferably between about 6 and 15 wt %.

While the present invention is suited for use with any type of light emitting device including those emitting red and yellow regions, it may be particularly beneficial when used with LEDs emitting in the green blue and/or UV regions where phosphor conversion is usually employed. Representative examples of green blue and/or UV emitting LEDs are those referred to as gallium nitride based.

One exemplary type of LED design provided for demonstration purposes only is the following: the materials made of AlₓGa_{y}In(_{1-x-y})N where both X and Y is between 0 and 1(0≦X≦1, 0≦Y≦1) and wherein a narrower bandgap GaN-based light-emitting structure is sandwiched between single or multiple layers of wider bandgap GaN-based structures with different conductivity types on different sides of the light-emitting structure.

Of course, the present invention is not limited thereto. Moreover, the present invention is believed beneficial with LEDs of any construction and, particularly those where a relatively thick substrate is utilized. Accordingly, the present invention can function with radiation of any wavelength provided phosphor compatibility exists. Similarly, the present invention is compatible with double heterostructure, multiple quantum well, single active layer, and all other types of LED designs. For example, the LED may contain at least one semiconductor layer based on GaN, ZnSe or SiC semiconductors. The LED may also contain one or more quantum wells in the active region, if desired. Typically, the LED active region may comprise a p-n junction comprising GaN, AlGaN and/or InGaN semiconductor layers. The p-n junction may be separated by a thin undoped InGaN layer or by one or more InGaN quantum wells.

The present invention can operate with any suitable phosphor material or combinations of phosphor materials. Moreover, provided that a phosphor which is compatible with the selected LED is used, the present invention can improve the device performance. Importantly, this means that no requirement exists in the invention with respect to the wavelength generated by the LED, the wavelength the phosphor excites or re-emits, or at the overall wavelength of light emitted by the light emitting device. Nonetheless, several exemplary phosphor systems are depicted below to facilitate an understanding of the invention.

Conventionally, a blue LED is an InGaN single quantum well LED and the phosphor is a cerium doped yttrium aluminum garnet (“YAG:Ce”), Y3Al5O12:Ce3⁺. The blue light emitted by the LED is transmitted through the phosphor and is mixed with the yellow light emitted by the phosphor. The viewer perceives the mixture of blue and yellow light as white light. One alternative phosphor is a TAG:Ce wherein terbium is substituted for yttrium. Other typical white light illumination systems include a light emitting diode having a peak emission wavelength between 360 and 420 nm, a first APO:Eu²⁺, Mn²⁺ phosphor, where A comprises at least one of Sr, Ca, Ba or Mg, and a second phosphor selected from at least one of:

a) A₄D₁₄O₂₅:Eu²⁺, where A comprises at least one of Sr, Ca, Ba or Mg, and D comprises at least one of Al or Ga;

b) 2AO*0.84P₂O₅*0.16B2O3):Eu²⁺, where A comprises at least one of Sr, Ca, Ba or Mg;

c) AD₈O₁₃:Eu²⁺, where A comprises at least one of Sr, Ca, Ba or Mg and D comprises at least one of Al or Ga;

d) A₁₀(PO₄)6Cl₂:Eu²⁺, where A comprises at least one of Sr, Ca, Ba or Mg; or

e) A₂Si₃O₈*2ACl₂:Eu²⁺, where A comprises at least one of Sr, Ca, Ba or Mg.

Accordingly, the phosphor system may be a blend of materials. For example, a white light illumination system can comprise blends of a first phosphor powder having a peak emission wavelength of about 570 to about 620 nm and a second phosphor powder having a peak emission wavelength of about 480 to about 500 nm to form a phosphor powder mixture adjacent the LED.

Exemplary polymeric encapsulants include silicones, several examples of which are available from GE-Toshiba Silicones, which can be used interchangeably as the transparent fill layer or as the phosphor dispersion layer. In addition, it is contemplated that the dispersion layer can be phosphor suspension a volatile organic solution such as a low molecular weight alcohol. Advantageously, the filler layer, the phosphor containing layer and the optic lens element can be formed/assembled according to any techniques known to the skilled artisan.

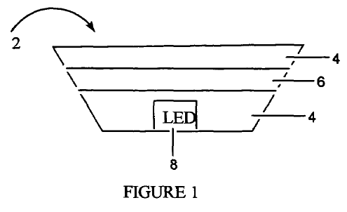

With reference to FIG. 1, a schematic view of a light source 2 is shown. The encapsulant material 4 is located adjacent to a phosphor layer 6. The phosphor layer 6 is excited by, for example, a UV/blue light emitted by the LED 8 and converts that light to visible white light.

Notwithstanding the depicted embodiment, the skilled artisan will recognize that any LED device configuration may be improved by the inclusion of the present inventive encapsulant composition. The embodiment specifically described herein is meant to be illustrative only and should not be construed in any limiting sense. For example, the encapsulant material of the present invention may be blended with a phosphor layer for phosphor binder applications.

In the following, the present invention will be described in more detail with reference to non-limiting examples. These examples are for the purposes of illustration only and should not be construed in any limiting sense.

### EXAMPLES

### Synthesis of Tris(Beta-(3,4-epoxycyclohexyl)ethyldimethylsiloxy)phenylsilane

A 250 ml flask equipped with mechanical stirrer, thermometer, condenser, addition funnel and nitrogen inlet was charged with 44.2 g (0.33 mols) of 4-vinylcyclohexeneoxide, 30 g of n-octane and 3 ppm of rhodium (III) sulfide complex [RhCl₃(Bu₂S)₃]. The solution was heated to 90° C. at which point a solution of 33 g (0.1 mols) of tris(dimethylsiloxy)phenylsilane in 30 ml of n-octane was added drop-wise to the reaction mixture. A mild exotherm took place and the temperature rose to 105° C. The silicone hydride addition was completed in 1 hr. The reaction mixture was heated with stirring overnight under nitrogen. IR analysis showed more than 99% consumption of Si—H next morning. At that point solvent and residual 4-vinylcyclohexeneoxide were removed on a rotary evaporater at 70° C./1 Torr to afford 69 g of the desired epoxy-functional oligosiloxane with high refractive index n^{D}₂₅=1.4974.

¹H, ²⁹Si NMR and LC confirmed the structure and purity of the desired product.

### Synthesis of 1,5-bis(Beta-(3,4-epoxycyclohexyl)ethyldimethylsiloxy)-3,3-diphenyltrisiloxane

A 250 ml flask equipped with mechanical stirrer, thermometer, condenser, addition funnel and nitrogen inlet was charged with 41.1 g (0.33 mols) of 4-vinylcyclohexeneoxide, 30 g of n-octane and 3 ppm of rhodium (III) sulfide complex [RhCl₃(Bu₂S)₃]. The solution was heated to 90° C. at which point a solution of 50 g (0.15 mols) of bis(dimethylsiloxy)diphenylsilane in 30 ml of n-octane was added drop-wise to the reaction mixture. A mild exotherm took place and the temperature rose to 105° C. The silicone hydride addition was completed in 1 hr. The reaction mixture was heated with stirring overnight under nitrogen. IR analysis showed more than 99% consumption of Si—H next morning. At that point solvent and residual 4-vinylcyclohexeneoxide were removed on a rotary evaporater at 70° C./1 Torr to afford 85 g of the desired epoxy-functional oligosiloxane with high refractive index n^{D}₂₅=1.5187.

¹H, ²⁹Si NMR and LC confirmed the structure and purity of the desired product.

### Synthesis of 1,7-bis(Beta-(3,4-epoxycyclohexyl)ethyldimethylsiloxy)-3,3,5,5-tetraphenyltetrasiloxane

A 250 ml flask equipped with mechanical stirrer, thermometer, condenser, addition funnel and nitrogen inlet was charged with 26.8 g (0.2 mols) of 4-vinylcyclohexeneoxide, 30 g of n-octane and 3 ppm of rhodium (III) sulfide complex [RhCl₃(Bu₂S)₃]. The solution was heated to 90° C. A solution of 41.1 g (0.08 mols) of 1,7-bis(dimethylsiloxy)-3,3,5,5-tetraphenyltetrasiloxane in 30 ml of n-octane was added drop-wise to the reaction mixture. A mild exotherm took place and the temperature rose to 102° C. The addition of silicone hydride was completed in 1 hour. The reaction mixture was heated with stirring under nitrogen overnight. Next morning, IR analysis showed more than 99% consumption of Si—H. At that point, solvent and residual 4-vinylcyclohexeneoxide were removed on rotary evaporater at 70° C./1 Torr to afford 60.6 g of the desired epoxy-functional oligosiloxane with high refractive index n^{D}₂₅=1.5416.

¹H, ²⁹Si NMR and LC confirmed the structure and purity of the desired product.

Although the invention has been described with reference to the exemplary embodiments, various changes and modifications can be made without departing from the scope and spirit of the invention. These modifications are intended to fall within the scope of the invention, as defined by the following claims.

We claim:

1. An encapsulant composition comprising:
a. an epoxy composition including at least a silicone group and a phenyl group, and
b. a curing agent.

2. The composition of claim 1 wherein said epoxy composition includes at least two silicone groups.

3. The composition of claim 1 wherein said epoxy has the formula:
MₐM′_{b}D_{c}D′_{d}TₑT′_{f}Q_{g}
where the subscripts a, b, c, d, e, f and g are zero or a positive integer, subject to the limitation that the sum of the subscripts b, d and f is one or greater; where M has the formula:
R¹₃SiO_{1/2},
M′ has the formula:
(Z)R²₂SiO_{1/2},
D has the formula:
R³₂SiO_{2/2},
D′ has the formula:
(Z)R⁴SiO_{2/2},
T has the formula:
R⁵SiO_{3/2},
T′ has the formula:
(Z)SiO_{3/2},
and Q has the formula SiO_{4/2}, where each R¹, R², R³, R⁴, R⁵ is independently at each occurrence a hydrogen atom, C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents an epoxy group. The term “alkyl” as used in various embodiments of the present invention is intended to designate both normal alkyl, branched alkyl, aralkyl, and cycloalkyl radicals. Normal and branched alkyl radicals are preferably those containing in a range between about 1 and about 12 carbon atoms, and include as illustrative non-limiting examples methyl, ethyl, propyl, isopropyl, butyl, tertiary-butyl, pentyl, neopentyl, and hexyl. Cycloalkyl radicals represented are preferably those containing in a range between about 4 and about 12 ring carbon atoms. Some illustrative non-limiting examples of these cycloalkyl radicals include cyclobutyl, cyclopentyl, cyclohexyl, methylcyclohexyl, and cycloheptyl. Preferred aralkyl radicals are those containing in a range between about 7 and about 14 carbon atoms; these include, but are not limited to, benzyl, phenylbutyl, phenylpropyl, and phenylethyl. Aryl radicals used in the various embodiments of the present invention are preferably those containing in a range between about 6 and about 14 ring carbon atoms.

4. The composition of claim 1 wherein said epoxy composition is selected from tris(Beta-(3,4-epoxycyclohexyl)ethyldimethylsiloxy)phenylsilane, 1,5-bis(Beta-(3,4-epoxycyclohexyl)ethyldimethylsiloxy)-3,3-diphenyltrisiloxane, 1,7-bis(Beta-(3,4-epoxycyclohexyl)ethyldimethylsiloxy)-3,3,5,5-tetraphenyltetrasiloxane and mixtures thereof.

5. The composition of claim 1 further including a cycloaliphatic group.

6. The composition of claim 1 wherein said curing agent is selected from the group consisting of resins obtained by the condensation or co-condensation of phenols and naphthols with aldehydes, aralkyl phenolic resins, amines, amides, phenols, thiols, carboxylic acids, carboxylic anhydrides, and mixtures thereof.

7. The composition of claim 1 further including a coupling agent.

8. The composition of claim 7 wherein said coupling agent is selected from the group consisting of vinyltrichlorosilane, vinyltriethoxysilane, vinyltris(β-methoxyethyoxy) silane, γ-methacryloxypropyltrimethoxysilane, β-(3,4-epoxydicyclohexyl)ethyltrimethoxysilane, γ-glycidoxypropyltrimethoxysilane, vinlytriacetoxysilane, γ-mercaptopropyltrimethoxysilane, γ-aminopropyltriethoxysilane, γ-[bis-(β-hydroxyethyl)]amino-propyltriethoxysilane, N-β-(aminoethyl)-γ-aminopropyltrimethoxysilane, γ-(β-aminoethyl)aminopropyldimethoxymethylsilane, N-(trimethoxysiliylpropyl)ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltrimethoxysilaen, vinyltrimethoxysilane and γ-mercaptopropylmethyldimethoxysilane, isopropyltriisosteroyl titanate, isopropyltris(diocyl pyrophosphate) titanate, isopropyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isopropyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisopropylbis(dioctyl phosphite) titanate; and mixtures thereof.

9. A method for forming an encapsulant composition comprising the step of mixing together an epoxy composition including at least a silicone and a phenyl group and a curing agent.

10. An electronic chip package comprising:
a. an encapsulant composition comprised of an epoxy composition including a silicone group and a phenyl group, and a curing agent;
b. an electronic chip at least partially encapsulated by said composition; and
c. a phosphor.

11. The composition of claim 1 wherein said epoxy composition includes at least two silicone groups.

12. The composition of claim 1 wherein:
MₐM′_{b}D_{c}D′_{d}TₑT′_{f}Q_{g}
where the subscripts a, b, c, d, e, f and g are zero or a positive integer, subject to the limitation that the sum of the subscripts b, d and f is one or greater; where M has the formula:
R¹₃SiO_{1/2},
M′ has the formula:
(Z)R²₂SiO_{1/2},
D has the formula:
R³₂SiO_{2/2},
D′ has the formula:
(Z)R⁴SiO_{2/2},
T has the formula:
R⁵SiO_{3/2},
T′ has the formula:
(Z)SiO_{3/2},
and Q has the formula SiO_{4/2}, where each R¹, R², R³, R⁴, R⁵ is independently at each occurrence a hydrogen atom, C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents an epoxy group. The term “alkyl” as used in various embodiments of the present invention is intended to designate both normal alkyl, branched alkyl, aralkyl, and cycloalkyl radicals. Normal and branched alkyl radicals are preferably those containing in a range between about 1 and about 12 carbon atoms, and include as illustrative non-limiting examples methyl, ethyl, propyl, isopropyl, butyl, tertiary-butyl, pentyl, neopentyl, and hexyl. Cycloalkyl radicals represented are preferably those containing in a range between about 4 and about 12 ring carbon atoms. Some illustrative non-limiting examples of these cycloalkyl radicals include cyclobutyl, cyclopentyl, cyclohexyl, methylcyclohexyl, and cycloheptyl. Preferred aralkyl radicals are those containing in a range between about 7 and about 14 carbon atoms; these include, but are not limited to, benzyl, phenylbutyl, phenylpropyl, and phenylethyl. Aryl radicals used in the various embodiments of the present invention are preferably those containing in a range between about 6 and about 14 ring carbon atoms.

13. The composition of claim 1 wherein said epoxy composition is selected from tris(Beta-(3,4-epoxycyclohexyl)ethyldimethylsiloxy)phenylsilane, 1,5-bis(Beta-(3,4-epoxycyclohexyl)ethyldimethylsiloxy)-3,3-diphenyltrisiloxane, 1,7-bis(Beta-(3,4-epoxycyclohexyl)ethyldimethylsiloxy)-3,3,5,5-tetraphenyltetrasiloxane and mixtures thereof.

14. The composition of claim 1 further including a cycloaliphatic group.

15. The composition of claim 1 wherein said curing agent is selected from the group consisting of resins obtained by the condensation or co-condensation of phenols and naphthols with aldehydes, aralkyl phenolic resins, amines, amides, phenols, thiols, carboxylic acids, carboxylic anhydrides, and mixtures thereof.

16. The composition of claim 1 further including a coupling agent.

17. The composition of claim 7 wherein said coupling agent is selected from the group consisting of vinyltrichlorosilane, vinyltriethoxysilane, vinyltris(β-methoxyethyoxy) silane, γ-methacryloxypropyltrimethoxysilane, β-(3,4-epoxydicyclohexyl)ethyltrimethoxysilane, γ-glycidoxypropyltrimethoxysilane, vinlytriacetoxysilane, γ-mercaptopropyltrimethoxysilane, γ-aminopropyltriethoxysilane, γ-[bis-(β-hydroxyethyl)]amino-propyltriethoxysilane, N-β-(aminoethyl)-γ-aminopropyltrimethoxysilane, γ-(β-aminoethyl)aminopropyldimethoxymethylsilane, N-(trimethoxysiliylpropyl)ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltrimethoxysilaen, vinyltrimethoxysilane and γ-mercaptopropylmethyldimethoxysilane, isopropyltriisosteroyl titanate, isopropyltris(diocyl pyrophosphate) titanate, isopropyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isopropyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisopropylbis(dioctyl phosphite) titanate; and mixtures thereof.

18. The package of claim 10 wherein said phosphor is dispersed in said encapsulant.
